(19) United States
(12) Patent Application Publication
(10) Pub. No.: US 2003/0041307 A1
(43) Pub. Date: Feb. 27, 2003

(54) Electronic dictionary system with a tree structure and its output

(76) Inventor: Jong-Won Park, Daejeon-shi (KR)

Correspondence Address: Hemant H. (Shashi) Kewalramani, Howrey Simon Arnold & White, LLP, 750 Bering Drive, Houston, TX, 77057-2198, US

(21) Appl. No.: 10/219,615

(22) Filed: Aug. 15, 2002

(30) Foreign Application Priority Data
Aug. 24, 2001 (KR) 2001-51398
Oct. 9, 2001 (KR) 10-2001-0087060

(51) Int. Cl. G09G 5/00

(52) U.S. Cl. 715/532

(57) ABSTRACT

The present invention relates to an electronic dictionary system with a tree structure and its output, or more particularly to an electronic dictionary system and its output, which comprises all the words in a dictionary in a tree structure, wherein said system displays a word in a tree structure or in specified color allocated by said tree structure; allows easy comprehension in a visual manner by relating the meaning of the word to the general association of its adjacent words; and allows expression of an inputted sentence in a flow of specified colors indicating the basic concepts.

### CROSS REFERENCE TO RELATED APPLICATIONS

This application claims priority under 35 U.S.C. §119(a) to Korean Patent Application Nos. 2001-0051398, filed in Korea on Aug. 24, 2001 and 2001-0062112, filed in Korea on Oct. 9, 2001, which are incorporated herein by reference to its entirety.

### FIELD OF THE INVENTION

The present invention relates to an electronic dictionary system with a tree structure and its output, or more particularly to an electronic dictionary system and its output, which comprises all the words in a dictionary in a tree structure, wherein said system displays a word in a tree structure or in specified color allocated by said tree structure; allows easy comprehension in a visual manner by relating the meaning of the word to the general association of its adjacent words; and allows expression of an inputted sentence in a flow of specified colors indicating the basic concepts.

### BACKGROUND OF THE INVENTION

Generally, man performs perceptive acts of a variety. They are motivated by his inborn faculty of perception and they are expressions of various ideas he comes to embrace in the form of literature, science, the arts, etc.

Of these all, expression of thoughts and ideas of high level, in particular, by means of a language and letters for exchange with and among his fellows is the most common aspect of man's everyday life and, probably, a pride for man alone.

Yet conveyance of ideas via letters is only possible by the writing systems certain masses of persons acquire by learning and share among themselves, the activity attributable to the postnatal and secondary activities of man's brains.

Man's brains react to external influences perceived and conveyed by his sense organs and form them into particular concepts, which he records with letters or transmits to others, thereby materializing exchange of ideas. Words transcribed in letters agreed upon to mean a given feeling (or idea) represent particular ideas.

Man uses words as media for exchange of ideas, as said above. Yet, in actual exchange, conveyance of one's idea by means of words must pass the two steps of work of transforming one's idea in his mind into appropriate words and of giving them outward expression, while the other also has, on his part, to undertake the two steps of work of perceiving the acoustically or visually expressed words and of transforming them into the ideas which the words represent.

Conveyance of an idea (thought) by words is hardly straightforward enough, therefore, and the speed of conveyance is slow, precise conveyance of ideas being difficult on occasions due to some differences or peculiarities of concepts pertaining to words which each individual is in possession of.

Since words are not the emotions or feelings themselves to be had through the variegated hues visually perceivable but require, for perception, the mediation of such mental activities like those of highly logical circuits which convert words into concepts or ideas, they are hardly free from failure in direct sensory appeal of the feelings they carry.

Works of the fine arts, unlike words, can do the straightforward conveyance of emotions through delicate harmony of hues, and it is only because a direct conveyance of emotions is accomplished through vision.

It is for this feature, for instance, that conveyance through hues is considered particularly preferred as a technique of advertisement which especially demands immediate and vivid transmission of messages.

If conveyance of ideas is rendered possible through hues, which are thus regarded as the fastest and most straightforward in man's sensation, it may prove a useful implement for conveyance of ideas in many a different field.

As to dictionaries, intended to help people with correct use of words, which are the very tools indispensable for conveyance of man's ideas, most of them are mere collections of words arranged in the alphabetical order of their first letters.

In the case of conventional dictionaries, especially the electronic dictionaries which are of growing popularity because of their convenience, too, interpretation or explanation of each entry only takes the form of a mere arrangement of explanatory words or sentences, and therefore it is practically impossible to see either the status of an entry in the general system of words it occupies or its relationships to other words.

In the system of conventional electronic dictionaries, therefore, there is difficulty in comprehensively grasping the relationships which an entry word has with other words in its neighborhood.

The present time witnesses the rise of man's wishes for various forms of self-expression and is in demand of various means of expressing his ideas, while at the same time man has desire to learn, visually, only the specific meaning (idea) he needs of all information descriptive of other persons' intention, but there is indeed no efficient means to satisfy such a desire of his.

### SUMMARY OF THE INVENTION

The present invention has been perfected with an objective to overcome all such difficulties or problems inherent in the conventional electronic dictionary systems and provide a new system, by which the interrelationships of words with other words for the neighboring ideas can be seen with ease.

Another objective of the present invention is to provide an output product of the new system giving words' structures in the interrelationship with their neighboring words.

A third objective of the present invention is to provide an electronic dictionary system by which a series of sentences can be output in a flow of the colors expressive of particular ideas.

A fourth objective of the present invention is to facilitate perception of the changes of man's feelings or natures through changes of hues.

The present invention aimed at achievement of all these objectives is described in detail below, the attached drawings being referred to whenever deemed desirable.

### BRIEF DESCRIPTION OF DRAWINGS

FIG. 1 is a conceptual diagram to show the tree structure with the word ‘ecstasy’ as a basic word according to one example of the present invention.

FIG. 2 is a conceptual diagram to show the tree structure with the word ‘virtuous’ as a basic word according to another example of the present invention.

FIG. 3 is a drawing, which shows one example of output according to the present invention.

FIG. 4 shows a drawing, which shows another example of output according to the present invention.

FIG. 5 shows a drawing, which shows still another example of output according to the present invention.

### DESCRIPTION OF THE PREFERRED EMBODIMENTS

The present invention is founded on the basis of a rendition of words in tree-like structures.

In other words, each entry word is expressed in a tree-like structure.

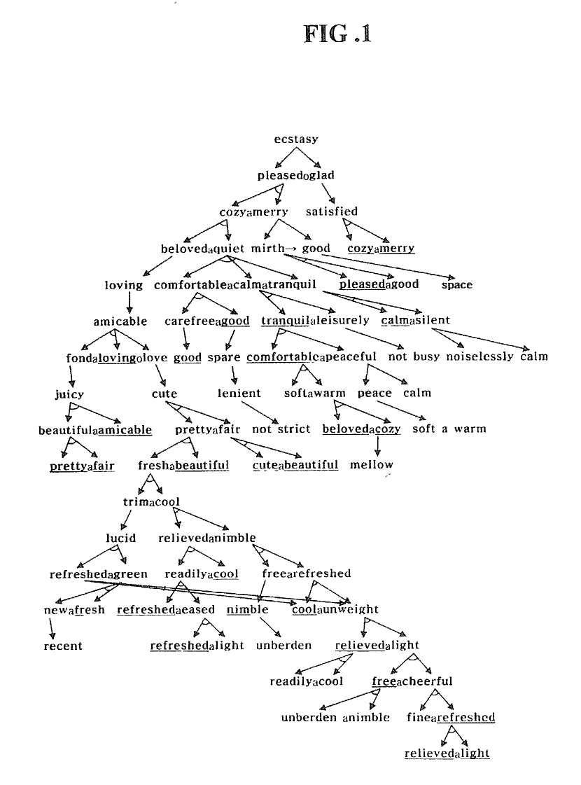

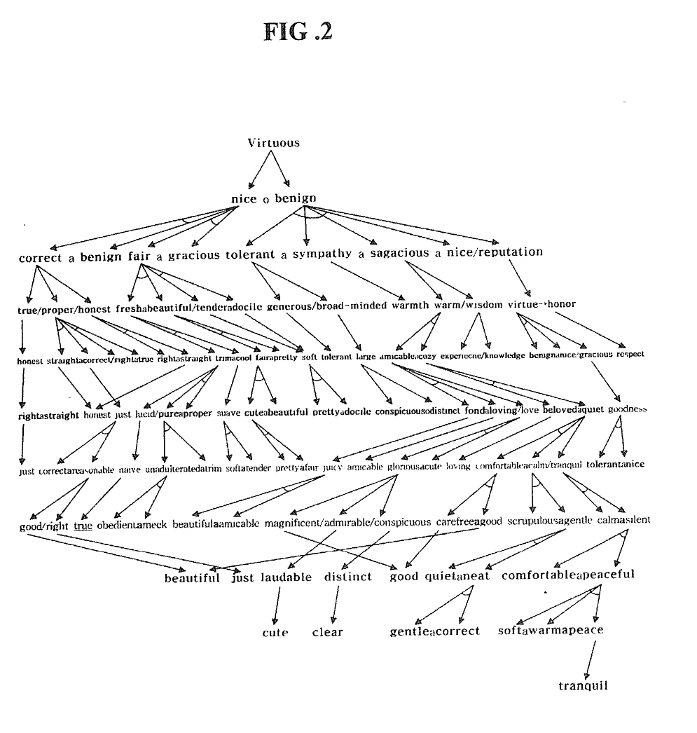

The tree-like structure, as will be seen in FIGS. 1 and 2 below, is made of a framework, in which a basic word for a basic concept is placed at the tree-top, followed beneath it by lesser words on the first lower branches explaining the basic word above, which, in turn, are followed beneath by still lesser words on the second lower branches explaining the first lower branch words above, once again followed beneath by still lesser words on the third lower branches explaining the second lower branch words above, yet to be followed again and again in continuation by words of lesser statures only to end at an xth lower branches, all these ramifications together forming the structure of a tree.

Many branches constituting a huge whole tree structure, an electronic dictionary system is so compiled that every word finds its places somewhere on any one or more particular branches of an individual tree structure.

Such a tree-structure preferably forms the basic framework of the memory system basically provided by an electronic dictionary system, and can also be made use of in many various devices and methods which must have their expression by way of words or vocabulary.

Now FIGS. 1 and 2 show examples of individual tree structures, the branches arranged laterally, constituting the entire tree structure, in which each individual branch neighbors other individual trees with the closest relationships; a word on the outermost side of a branch may very well overlap a word on its immediate neighbor, and in such a case a word on the interlacing branches may either be decided where it is to be taken to belong to by its greater proximity to either of the two or just be left alone as it overlaps.

In FIG. 1, the word ‘ecstasy’ on the top of the tree structure makes the basic word, and the words ‘pleased’ and ‘glad’ being the first lower branch words, and the words ‘cozy’, ‘merry’, and ‘satisfied’ the second-lower branch words, to be followed beneath by the third, fourth, fifth lower branch words and so on in the same way.

The numerical figures shown on the right side of the tree structure indicate the orders of the lower branches, or stand for the depth of each word in significance.

Below, a preferable method for organizing such a tree structure as above is given in detail.

First it may be that for each entry word in a dictionary, the sentences to explain it can be arranged in series, then the sentences which explain each word in the foregoing explanatory sentences are arranged in series, and by repetition of this way of arrangement a number of explanatory sentences and the words in them, all derived from the basic, can be orderly arranged.

Illustrations of this are clearly to be seen in Examples 1 and 2.

### EXAMPLE 1

ecstasy: gladness and pleased

pleased: cozy and merry (because of internal reasons)

glad: satisfied (because of external reasons)

cozy:

\mathring{1} soft from a feeling of warmth and comfort

\mathring{2} (in winter weather) windless and warm

\mathring{3} (feeling or atmosphere) not sad, beloved, and quiet

merry: mirthful and feeling happy, good

satisfied: feeling a warm in mind and delightful, cozy and merry

beloved: closely attached, full of tenderness, loving

quiet: comfortable, calm, having no trouble and tranquil

mirth: elegance and nice taste, please & good

good:

\mathring{1} clear (weather), clean

\mathring{2} happy

\mathring{3} beautiful

\mathring{4} good, spare

\mathring{5} efficient

\mathring{6} better

\mathring{7} no matter, no problem

\mathring{8} auspicious

\mathring{9} make peace

\mathring{10} appropriate

\mathring{11} insensitive or benumbed

\mathring{12} not bad to hear or nice to the ear

\mathring{13} word of agreement with or appreciation of what the other one says

loving:

\mathring{1} have a kind heart

\mathring{2} warm acquaintance, rely amicable

comfortable:

\mathring{1} carefree and good, soft and warm

\mathring{2} not awkward or well and safe

calm:

\mathring{1} soundless and silent

\mathring{2} not fussy but scrupulous and meek

\mathring{3} not noisy tranquil and leisurely

\mathring{4} not quarrelsome but tranquil and leisurely

tranquil: calm and silent, peaceful and comfortable

amicable:

\mathring{1} affectionate and friendly

\mathring{2} fond and loving or love

\mathring{3} loveable enough, worthy of endearment

carefree:

\mathring{1} contented, satisfied, good, having no pains nor inconveniences

\mathring{2} easy, not painful nor troublesome

leisurely: not busy, spare time (done in a relaxed way, with out hurrying)

silent:

\mathring{1} noiseless, calm

\mathring{2} placid

\mathring{3} peaceful without making complaints

fond:

\mathring{1} juicy, to like come one very much

\mathring{2} effective and steady going

love: cute and loveable

spare: additional, lenient

peaceful: have a peaceful feeling, calm

peace:

\mathring{1} (atmosphere) soft and warm without any problems

\mathring{2} tranquil, without war

juicy:

\mathring{1} beautiful and amicable in various ways

\mathring{2} amusing and pleased

\mathring{3} feeling interested

cute: fair and pretty, beautiful

lenient:

\mathring{1} not strict

\mathring{2} (living) rich, wealthy

soft:

\mathring{1} not rough but mellow

\mathring{2} (of nature) sweet and docile

warm:

\mathring{1} (temperature) enough to make persons feel comfortable

\mathring{2} (feeling or sensation) beloved and cozy

beautiful:

\mathring{1} fair, good looking and satisfactory to mind, pretty

\mathring{2} good and commendable

\mathring{3} private and personal

fun: juicy, have pleasure and mirth

pretty:

\mathring{1} fresh and beautiful

\mathring{2} soft and not rough

\mathring{3} little and thin

\mathring{4} tender and mild no trouble, no quarrel, calm and comfortable

fair: cute and beautiful

mirth: pleased and refreshing

fresh:

\mathring{1} (feeling or sensation) clear, trim and cool

\mathring{2} (action) smart and quick

\mathring{3} (shape) compact and chic

refreshed: feel rid of burden and unworried, cool and unweight

trim:

\mathring{1} neither dirty nor filthy

\mathring{2} free of impurities and lucid

\mathring{3} all gone and utterly empty

\mathring{4} (nature and behavior) pure and righteous, free of faults or irregularities, pure and proper

unweight: relieved and light

cool:

\mathring{1} rid of heat

\mathring{2} feel relived (with problems solved) and nimble

\mathring{3} (speech and manner) undisturbed or open-minded

\mathring{4} feel refreshed upon relief of nature

\mathring{5} feel openness (nothing to block sight)

\mathring{6} (tastes of soup or the like) not too thick but light and properly thin

lucid:

\mathring{1} plain-minded, plain-headed

\mathring{2} (things) clean and transparent

\mathring{3} (weather or voice) neither cloudy nor thick, refreshed and green

\mathring{4} (air) fresh and invigorating

\mathring{5} (person) naive and unsophisticated

\mathring{6} clean, free of corruption or dishonesty

relieved:

\mathring{1} feel satisfied as if water brash is cured off

\mathring{2} readily and cool (upon removal of unrest or worries)

nimble:

\mathring{1} quite light

\mathring{2} feel quite free, quite refresh

light:

\mathring{1} less weight, easy to lift or wield

\mathring{2} less important

\mathring{3} insincere

\mathring{4} free and cheerful

\mathring{5} weak

green:

\mathring{1} new and fresh

\mathring{2} fresh and paint

readily:

fairly handy (easy to lift or use)

\mathring{2} (feel) relieved and light, refreshed and eased

free:

\mathring{1} unburden and nimble

\mathring{2} easy to handle and not serious

\mathring{3} (not burdensome) light and fine

cheerful:

\mathring{1} feel light and revived, fine and refreshed

\mathring{2} light and nimble of bodily movement

new:

\mathring{1} (make or create) recent

\mathring{2} different from the past

\mathring{3} feel keenly ness towards the necessity

eased:

\mathring{1} feel good and light-hearted and refreshed

\mathring{2} (food) clean and nice

fine:

\mathring{1} quite easy (to lift or handle)

\mathring{2} (feel) relieved and light

### EXAMPLE 2

Virtuous: nice or benign

Nice: Correct and benign (in speech and manner), fair and gracious (of mind)

benign:

\mathring{1} broad of mind, sympathy, sagacious and rice, reputed as virtuous, iderance

\mathring{2} look sagacious

\mathring{3} suitable (the hour or times), good

correct:

\mathring{1} untwisted, unbent, just

\mathring{2} truthful, righteous

\mathring{3} honest or proper or true

\mathring{4} warm, being shined by the sun

fair:

\mathring{1} fresh and beautiful

\mathring{2} not rough but soft

\mathring{3} tiny and thin

\mathring{4} tender and docile

\mathring{5} comfortable without trouble or disturbances

tolerant: broad-minded, generous

sympathy:

\mathring{1} man's heart, sensation, condition

\mathring{2} warmth toward others

\mathring{3} (of old) bribe or gift

sagacious: wisdom and clever, warm

wisdom: ability to distinguish right and wrong, experience, knowledge

reputation: fame and honor won by virtue

true:

\mathring{1} honest, absence of falsity

\mathring{2} true to facts

proper: straightforward ad correct, right and true

honest: right and straight (of mind)

fresh:

\mathring{1} (feeling or sensation) trim and cool

\mathring{2} (action) smart and quick

\mathring{3} (shape) compact and chic

beautiful:

\mathring{1} fair, pair sweet looking and (satisfactory to mind) pretty

\mathring{2} good and commendable

\mathring{3} private and personal

tender: compliant and mild in nature, soft

docile:

\mathring{1} mild of nature, soft

\mathring{2} doesn't taste too strong

\mathring{3} things are without a hitch

broad:

\mathring{1} large area

\mathring{2} long width

\mathring{3} (mind) tolerant

\mathring{4} associated with many people

large:

\mathring{1} (length or volume) rather unusual

\mathring{2} (height) greater than normal

\mathring{3} more hard, extreme and stronger than normal

\mathring{4} (magnanimity) broad

\mathring{5} (person's nature) conspicuous or distinct

\mathring{6} (a month) have more number of days than normal days in a month

\mathring{7} extended range

generous: tolerant in mind

warm:

\mathring{1} (temperature) enough to make persons feel comfortable

\mathring{2} (feeling or sensation) amicable and cozy

virtue: benign and nice behavior, gracious behavior

honor: credit and popularity, respect

straight:

\mathring{1} right

\mathring{2} unbent, honest

right: fit to class, reasonable, just

trim:

\mathring{1} neither dirty nor filthy

\mathring{2} free of impurities and lucid

\mathring{3} all gone and utterly empty

\mathring{4} (nature and behavior) pure and righteous, free of faults or irregularities, pure and proper or lucid

cool:

\mathring{1} rid of heat, suave

\mathring{2} feel relived (with problems solved) and nimble

\mathring{3} (speech and manner) undisturbed or open-minded

\mathring{4} feel refreshed upon relief of nature

\mathring{5} feel openness (nothing to block sight)

\mathring{6} (tastes of soup or the like) not too thick but light and just properly thin

fair: cute and beautiful

magnificent:

\mathring{1} (speech or personality) very good

\mathring{2} praise worthy, good, well or wonderful

\mathring{3} (face, attitude, view) very beautiful, satisfactory

admirable: magnificent and glorious, laudable

soft:

\mathring{1} not rough but mellow

\mathring{2} (of nature) pretty and docile

conspicuous:

\mathring{1} be known, easy to notice

\mathring{2} distinct

cute: pretty and fair

distinct: make clear

amicable:

\mathring{1} affectionate and friendly

\mathring{2} fond and loving or love

\mathring{3} loveable enough to worth endearment

cozy:

\mathring{1} soft from a feeling of warmth and comfort

\mathring{2} (in winter weather) windless and warm

\mathring{3} (feeling or atmosphere) not sad, beloved and quiet

gracious: having goodness

goodness:

\mathring{1} tolerant and nice character

\mathring{2} helping, favor, indebtedness

just: right and proper, reasonable

lucid:

\mathring{1} plain-minded, plain-headed

\mathring{2} (things) clean and transparent

\mathring{3} (weather or voice) neither cloudy nor thick

\mathring{4} (air) fresh and invigorating

\mathring{5} (person) naive and unsophisticated

\mathring{6} clean, free of corruption or dishonesty

pure:

\mathring{1} clean and unadulterated, trim

\mathring{2} chaste and clean in body and mind

suave: (shape or character) soft and tender

glorious:

\mathring{1} magnificent, conspicuous

\mathring{2} (devotion) very admirable

\mathring{3} (prosperous or amazing

\mathring{4} extreme

laudable: (speech or act) to excel, very cute

fond:

\mathring{1} (pity)juicy

\mathring{2} to like someone very much, make effective and steady going

Loving:

\mathring{1} have a kind heart

\mathring{2} warm acquaintance, very amicable

love: cute and loveable, glorious

beloved: closely attached, full of tenderness, loving

quiet: peaceful, calm and comfortable and tranquil

reasonable:

\mathring{1} be pleased

\mathring{2} (in condition) suitable and good

\mathring{3} legal and right

naive: plain and true

unadulterated:

\mathring{1} obedient and meek

\mathring{2} (tastes of food) mild, meek, (mind) mild and docile

juicy:

\mathring{1} beautiful and amicable in various ways

\mathring{2} amusing and pleased

\mathring{3} feeling interested

comfortable:

\mathring{1} carefree and good

\mathring{2} not awkward or well and safe

calm:

\mathring{1} soundless and silent

\mathring{2} not fussy but scrupulous and gentle

\mathring{3} not noisy but calm and tranquil

\mathring{4} not quarrelsome but tranquil and leisurely

tranquil: calm, quite, silent and peaceful

good:

\mathring{1} clear (weather), clean

\mathring{2} happy

\mathring{3} beautiful

\mathring{4} good

\mathring{5} efficient

\mathring{6} better

\mathring{7} no matter, no problem

\mathring{8} auspicious

\mathring{9} make peace

\mathring{10} appropriate

\mathring{11} insensitive or benumbed

\mathring{12} not bad to hear or nice to the hear

\mathring{13} word of agreement with or appreciation of what the other one says

carefree:

\mathring{1} contented, satisfied, good having no pains nor inconveniences

\mathring{2} easy, not painful nor troublesome

gentle:

\mathring{1} (peaceful of nature) quiet and neat of behavior

\mathring{2} not fussy but smart

\mathring{3} (a thing) good-looking and useful

\mathring{4} life is orderly and respectable

\mathring{5} calm, not rough or wild

silent:

\mathring{1} noiseless, calm

\mathring{2} placid, without moving

\mathring{3} peaceful, without making complaints, comfortable

neat:

\mathring{1} (attire) well-cared, tidy, and balanced

\mathring{2} (facial features) symmetrical and beautiful, gentle and correct

peaceful: have a peaceful feeling, calm, soft and warm

peace:

\mathring{1} (atmosphere) soft and warm without any problems

\mathring{2} tranquil, without war

\mathring{3} (manner) nowhere disturbed but gentle and correct

The words given in Examples 1 and 2 above make FIGS. 1 and 2, when they are arranged in a tree structure. FIG. 1 shows a tree-form organization of the words with ‘ecstasy’ as the basic (word, or idea), while FIG. 2, that of the word “virtuous’. Of course they are mere examples of individual tree-form organizations attempted to help comprehension of the idea, and it does not follow that the words ‘ecstasy’ and ‘virtuous’ must necessarily be placed on the top of the respective groups.

Nor does it follow that each word in the above examples must need be placed in that particular place assigned to it in the tree-forms (preferably, the tree structure could be erected in accordance with a standard dictionary to be elected for the purpose).

When all the words entered from a dictionary, are arranged in a tree structure, which frames the word belongs to a pertinent notion group through the process given above.

The words placed as the basic at the tree tops are each given an equal status, and all the other words are also regarded as having an equal status to the others in the branch or twig of the same degree, order, or rung in each individual tree structure.

In an individual tree, the lower branch a word occupies the farther it is removed from the basic word in its relation (meanwhile the depth of the idea getting the larger from the basic), and the relation of a word with the others in the same stem is taken, so to speak, as much removed from them as the number of the intervening branches indicates.

The cases connected with “and” and “or”, “synonym” or “parallel” meanings, and “causation” meanings given in the above 1 and 2 are differentiated in the FIGS. 1 and 2 by “a”, “o”, “/”.

The present invention is to provide an electronic dictionary system by building up a memory device including such a tree structure as one described above.

It needs no saying that the electronic dictionary system of the present invention preferably has, besides the above memory system, a device for inputting words or other symbols, a device of control to output particular output values by comparison of the data input by said input device with those stored in said memory system, and a device for outputting such data to be output under the control of said device of control.

It is preferable for the electronic dictionary system of the present invention to be capable of outputting the tree of the entered word (referred to by a user), too. In case the particular word stretches over two individual boughs both will be output, or only one of them will, and so will either a partly enlargement or contraction.

In the system of the present invention, a particular word in a tree will be afforded a particular color when inputting, so that it may be designated as a word of a basic color. This may be required to be put under the control of said control device.

In case a word is designated as a word of a basic color and in case this word is on a branch of a “P” rung, this particular word may be taken as a word on the top and the branches lower than the word's can again be numbered the first to the N-Pth in order.

Set up in the fashion described above, a word positioned in any place on any branch in a tree, designated for a particular color, and those other words positioned on the lower branches of the same tree are all given the same color, while those words on the lower branches will be given the same color but of different chroma, dependent upon their proximity to the principal word or whether they are mere qualifiers or not.

Colors being assigned, all outputs can be rendered in the designated basic colors and according to the flow of these colors.

This may prove a useful device in showing the compounds of series of ideas expressed in sentences, in flows of colors.

After inputting particular ideas desired by a user by designating particular colors, as said above, it is possible to show a desired sentence (or various expressions by words) in colors symbolizing the above particular ideas.

In an entered sentence, the words on the lower branches derived from the word, for which a basic color is designated, are shown in the color designated for the basic word, and said input sentence is output in the flow of the designated basic color.

In this case, the word for which a color is designated and those other words in the lower branches (designated anew, for the first to X˜P rungs) are all output in the same color but with difference in chroma, so that, preferably, these words will reflect their difference in proximity to the basic word and possibly their gradual change of depth in meaning.

It may also be possible to output each color by differentiating its intensity by the delicate difference in chroma to indicate the relative strength and impact of each word, dependent, for instance, upon whether or not each has a qualifier attached to it.

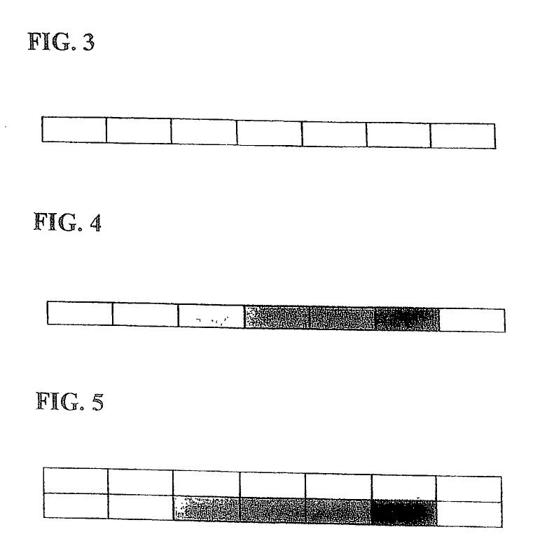

In the case of outputting in color, as described above, it is preferable to output input words in the form of a long belt in which all the words are arranged in their order of input, in the ways given in FIGS. 3 through 5, for instance.

Outputting the desired ideas in colors, as said above, will be illustrated below, making reference to actual examples.

To begin with, the sentences (or ideas in various expressions converted into sentences) preferred to be shown in desired colors are input by means of an inputting device (by the keyboard, conversion into letters by letter-recognition programs after reading by a scanner, or by any other devices capable of inputting letter codes).

An example, for illustration, is given herewith, of converting several sentences into color hues:

“He was in ecstasy doing the sculpture. After completion he stepped out into the garden. In the garden the sun was shining warmly. He felt easy and comfortable. Then she opened the gate and stepped into the garden. As usual, she was quite and fair In especial, the light and bright-colored dress she was in on this morning made him feel the more tender and warmer.”

When the above text, for instance, is input by an inputting device, designating the words ‘ecstasy’ and ‘virtuous’ as those for the basic colors, red and yellow (it is also possible to designate words for the basic colors before entering the sentences), the words (ideas) of these sentences are expressed by the words designated for the basic colors, and the controlling device operates as follows.

Namely the above text, represented by the ideas for designation of the basic colors—‘ecstasy’ and ‘virtuous’ and in terms of the depths of these ideas, the following example, 3, is obtained.

### EXAMPLE 3

“ecstasy (ecstasy: red, 1); warmly (ecstasy: red, 8); ecstasy (ecstasy: red, 6); pretty (ecstasy: red, 9); fair (ecstasy: red, 9); light (ecstasy: red, 15); warm (ecstasy: yellow, 8)”

In Example 3 above, the input words show the ideas (ecstasy, virtue) for designation of the basic colors given in the next brackets, the designated colors also named beside, and the depths of the ideas for designation of the basic colors indicated in numerical figures, (wherein, the basic concept for designation of the basic color is numbered 1, the figures rising as the rungs of the branches progress downward). The figures indicating the degrees of intensity can be differentiated by chromatic differences at the stage of outputting.

To elaborate, in the case of the word ‘pretty’, the designated word is ‘ecstasy’, but the depth is set at 9, and this FIG. 9, being somewhat large, is indicated in thick red, while the word ‘ecstasy’, being the very word ‘ecstasy’, the FIG. 1, is given the thinnest of all reds; wherefore, representing the same basic word and color, each word is so given a figure and designated a chromatic degree to fit it, thus differentiating the different depth of each in meaning.

The output information operated in the controlling device as in Example 3 above is displayed in a series of hues, as shown in FIG. 3. Having it output in a continuing series of hues in the form of a belt may be good enough, but display in other forms may also be possible if only shown in color hues.

The above exemplary text will become as follows, if shown with differentiation of the intensity of the ideas for designation of the basic colors:

### EXAMPLE 4

“ecstasy (ecstasy: red, 1); warmly (ecstasy: red, 4); very easy (ecstasy: red, 1): very pretty (ecstasy: red, 1); good-looking (ecstasy: red, 1); ‘light (ecstasy: red, 4); very warmly (ecstasy: red, 1)”

The words input in Example 4 above represent the ideas (ecstasy, virtue) designated for the basic colors given in the brackets beside them, the color hues being given next, and the intensity of the designated ideas for the basic colors next in the numerical figures. The numerical figures can be differentiated by the difference in chroma at the stage of outputting.

In other words, in the case of the word ‘very pretty’ the word ‘ecstasy’ is designated, and the degrees of intensity, from 1 through, are indicated by the decrease in thickness of even the same color, red or else, while the word ‘light’, though also representing the same ‘ecstasy’, being of the intensity indicated by 4 or so, is rendered a little redder, thus indicating the different degrees of intensity even in the same category.

As in Example 4 above, the output information operated in the controlling device is displayed through the outputting device in a series of continuing color hues, as shown in FIG. 4. Having it output in a continuing series of hues in the form of a belt may be good enough, but display in other forms may also be possible if only shown in color hues.

The degrees of intensity of the words designated for the basic colors are ranked in consideration of the number of their accompanying modifiers or according to the intensity of these modifiers themselves, and it is preferred that these ranks be indicated by positive numbers, commendably obtaining counsel of the reliable circles of linguists.

If it is desired that both the intensity and depth of the ideas designated for the basic colors be output together, these words may be input in the first place with such an instruction that the controlling device should have them output together with both intensity and depth.

The output at such times will be as shown in FIG. 5, combining in one both the belts of color hues in FIGS. 3 and 4, one in the upper box and the other in the lower. In other words, this example is preferably to output the hues for a single input word (idea) in two lines, either upper and lower, or left and right.

In other words, the upper or the left, for instance, will indicate the word (idea) designated for the basic color and its depth, while the lower or the right, again for instance, will indicate the word (idea) designated for the basic color and its intensity, the principle applicable here being the same as in the cases of FIGS. 3 and 4.

As shown in FIGS. 1 and 2, the individual trees for Examples 3 and 4 have the respective words designated for the basic colors positioned at the top of each, but this is only an example made for the sake of convenience. In practice, words designated for basic colors can possibly find their places anywhere in the many branches, lower or upper, yet even in such cases, too, the same principle for designation of the colors can be applied all right, wherein, of course, the rungs of the branches will be ranked starting with the words designated for the basic colors, well, to repeat, wherever these basic color words may be situated in the individual trees in fact, they are the basic, and the respectively numbered rungs of branches signify the depths of the basic concept reflected upon all the other words.

The output products then will indicate, by the changes of the colors, how the basic designated idea in a sentence goes on changing as the sentence proceeds. In other words, it may very well be possible to see how the depths and intensity of the word designated for the basic color develop by the frequency of the appearance of, and the flow of, the color hues as well as their thickness or thinness assigned to it on each occasion.

In the case of a novel it may help understand, visually, too, at a glance through the changes of the colors, how the emotions and sentiments of the protagonist, for example, grow as the story develops. Besides, it may help to catch sight of the development of the story also at a glance, not to say of an additional advantage of this system in the form of a graduation of the delicate procession of coloring—a remarkable attraction.

The ideas for designation of a basic color by the present invention may be of many kinds, the objects including such literary art works as poetry, novels, dramas, fairy tales, criticisms, essays, etc., in writing, such music works as performances, songs, such fine art works as paintings, sculptures, technical arts, along with films, plays, TV dramas, texts of lectures, academic publications, thesis, texts of adjudication, and everything in fact that can be expressed by man.

In the case of a work on a sheet like a painting, the ideas of each part or section of the work can be expressed in terms of their intensity and depths on a plane, in disregard of time.

As concerns a motion picture or a play on the stage, say, all such works as are erected on the flow or stream of time, their ideas are aligned in terms of time.

In all works in writing the changes with the transition of time can be given expression to.

The present invention can also output the individual trees containing an input word on a computer monitor or have them printed on a sheet of paper via an output device to help one grasp the ideological features of the word at sight.

An input device can also be connected using a number of computers joined with the Internet system, while an output device can be organized of the output devices of the huge number of computers joined together again via the Internet system.

All that is output by the system of the present invention can be produced on sheets of paper on which such tree structures themselves as are given in Examples 1 or 2 or the tables of their color hues are printed, or in the shape of CD's (compact disks) on which they are memorized. Of course, it can be outputted by monitors for themselves, or in 3-D holograms also.

As seen above, the present invention brings forth an effect that the meanings of a word can be comprehended in an overall association with the neighboring words and with ease by the sight.

Also, the present invention can help with easy comprehension of the ideas and implications contained in a creative writing through visualization of them in various hues of colors.

In the present invention it is possible to determine how well and how efficiently all the words entered in a Korean or an English-Korean dictionary, an encyclopedia, a dictionary of physical or philosophical terms or anything of the like are explained from their generic to specific levels, if they are rendered in the tree structures proffered in the present invention. In other words, if loops are found in them, they will indicate that the explanations are hardly proper. If anything of the sort be detected, ways can be thought of to eliminate it, therefore.

Again, if the dictionaries of some national languages are analyzed by organizing their entries in the tree-like structures proffered in the present invention, then the methodologies employed in each of them for explanation of words can be logically compared.

The present invention can be made very good use of when translating a language into another, for if a belt for the original and another for a foreign version are prepared by the method proffered in the present invention and compared with each other, the degree or extent of the agreement of the two belts with each other will help to see how well and correctly the translation has been performed. The difference between the two different languages in representation of ideas can also be seen.

Since it is possible by the present invention comprehensively to show the representative ideas contained in various creative writings at once by typical representation, the quick grasp of these various writings is possible, and since the messages of creative writings are possibly appreciated through changes of hues of colors reading can be enjoyed without tedium, while writing can also be encouraged this way contributing to the general promotion of man's cultural activities.

What is claimed is:

1. An electronic dictionary system with a tree structure, which comprises an individual tree structure containing a basic word forming a basic concept of the highest level; words of a branch substructure of the primary level, explaining said basic word; words of a branch substructure of the secondary level, explaining said words of the branch substructure of the primary level; and words of a branch substructure of the tertiary level, explaining the words of the branch substructure of the secondary level, which is extended to the branch substructure of an Xth level while adding additional levels in said manner, wherein said system comprises a memory unit of overall tree structure containing a multiple of said individual tree structures, in which each word belongs to a branch substructure of a specified level of said individual tree structure.

2. The electronic dictionary system with a tree structure according to claim 1, which comprises an input unit; a control unit which outputs specified output values by comparing information inputted through said input unit with the information stored in said memory unit; an output unit which outputs output by way of said control unit.

3. The electronic dictionary system with a tree structure according to claim 2, which comprises outputting an inputted word in an individual tree structure to which said inputted word belongs.

4. The electronic dictionary system with a tree structure according to claim 2, which comprises outputting respective antonyms of the words belonging to said individual tree structure.

5. The electronic dictionary system with a tree structure according to claim 4, which comprises outputting said antonym in an individual tree structure to which said antonym belongs.

6. The electronic dictionary system with a tree structure according to claim 2, which comprises outputting respective synonyms of the words belonging to said individual tree structure.

7. The electronic dictionary system with a tree structure according to claim 6, which comprises outputting said synonym in an individual tree structure to which said synonym belongs.

8. The electronic dictionary system with a tree structure according to claim 2 or 7, wherein said control unit has a function of inputting for designating a certain color to a word, thereby setting it as a designated word of basic color.

9. The electronic dictionary system with a tree structure according to claim 8, which comprises, in case of setting a designated word of basic color, setting said designated word of basic color at the highest level, and resetting sequentially the levels of branch substructures lower than the highest level, from the primary level to the (X-P)th level, if the designated word of basic color is located in the branch substructure of the Pth level within the individual tree structure.

10. The electronic dictionary system with a tree structure according to claim 9, which allows inputting of a sentence of many words; displaying, in basic color of the designated word, the words among the words in the inputted sentence, which are included in the branch structure derived from the designated word of basic color; and outputting said inputted sentence in a flow of basic colors in setting.

11. The electronic dictionary system with a tree structure according to claim 10, which comprises outputting the designated word of basic color and the words included in the branch substructure of the first level to the (X-P)th level of the designated word of basic color, wherein said words are displayed in graded chroma according to the levels of the colors indicated by said words.

12. The electronic dictionary system with a tree structure according to claim 10, which comprises displaying the words indicated in said colors in different chroma, depending on the qualification of various modifiers which modify said words, for showing the intensity of said words; and additionally outputting the flow of colors indicating the intensity of said words.

13. The electronic dictionary system with a tree structure according to claim 10, which comprises outputting said flow of colors in the form of a color band in continuous array according to the order of inputted words.

14. An output by means of one of claim 2 to 7.

15. The output according to claim 14, wherein said output is printed on paper.

16. The output according to claim 14, wherein said output is of a compact disk.

17. The output by means of claim 10.

18. The output according to claim 17, wherein said output is printed on paper.

19. The output according to claim 17, wherein said output is of a compact disk.

20. The output by means of claim 11.

21. The output according to claim 20, wherein said output is printed on paper.

22. The output according to claim 20, wherein said output is of a compact disk.
